(19) United States
(12) Patent Application Publication
(10) Pub. No.: US 2017/0313401 A1
(43) Pub. Date: Nov. 2, 2017

(54) ARM-AIRFRAME CONNECTING STRUCTURE AND UNMANNED AERIAL VEHICLE

(71) Applicant: ZEROTECH (SHENZHEN) INTELLIGENCE ROBOT CO., LTD., Shenzhen (CN)

(72) Inventors: Yaming TANG, Beijing (CN); Liang CHEN, Beijing (CN)

(73) Assignee: ZEROTECH (SHENZHEN) INTELLIGENCE ROBOT CO., LTD., Shenzhen (CN)

(21) Appl. No.: 15/378,902

(22) Filed: Dec. 14, 2016

(30) Foreign Application Priority Data
Apr. 27, 2016 (CN) 201620366873.9
Aug. 15, 2016 (CN) 201620883820.4

(51) Int. Cl. B64C 1/30; B64C 27/08; B64C 39/02

(52) U.S. Cl. CPC B64C 1/30; B64C 39/024; B64C 27/08; B64C 2201/108; B64C 2201/027

(57) ABSTRACT

An arm-airframe connecting structure and an unmanned aerial vehicle are provided by embodiments of the present disclosure. The arm-airframe connecting structure is configured to movably connect an airframe and an arm, and the arm is switchable between an unfolded position and a housed position with respect to the airframe. The arm-airframe connecting structure includes: at least one arm matching part provided on the arm; and at least one airframe matching part provided on the airframe. The at least one arm matching part and the at least one airframe matching part are configured to be bonded with each other so as to maintain at least one of the unfolded position and the housed position of the arm with respect to the airframe.

### TECHNICAL FIELD

Embodiments of the present disclosure relate to an arm-airframe connecting structure and an unmanned aerial vehicle.

### BACKGROUND

In order to reduce a volume of an unmanned aerial vehicle and facilitate carrying an unmanned aerial vehicle, a movable mechanism can be adopted to connect arms and an airframe of the unmanned aerial vehicle together. Therefore, when the unmanned aerial vehicle is in a non-working state, the arms can be housed so as to obtain portability. However, the existing movable mechanism cannot effectively lock positions of the arms, and the arms are easy to change their position so that excessive shake of the arms is caused during the flight process.

### SUMMARY

An embodiment of the present disclosure provides an arm-airframe connecting structure, configured to movably connect an airframe and an arm, the arm being switchable between an unfolded position and a housed position with respect to the airframe, wherein, the arm-airframe connecting structure includes: at least one arm matching part provided on the arm; and at least one airframe matching part provided on the airframe, wherein, the at least one arm matching part and the at least one airframe matching part are configured to be bonded with each other so as to maintain at least one of the unfolded position and the housed position of the arm with respect to the airframe.

Another embodiment of the present disclosure provides an unmanned aerial vehicle, including: an airframe; an arm movably connected to the airframe and switchable between an unfolded position and a housed position with respect to the airframe; and an arm-airframe connecting structure, including: at least one arm matching part provided on the arm; and at least one airframe matching part provided on the airframe, wherein, the at least one arm matching part and the at least one airframe matching part are configured to be bonded with each other so as to maintain at least one of the unfolded position and the housed position of the arm with respect to the airframe..

### BRIEF DESCRIPTION OF THE DRAWINGS

In order to more clearly illustrate the technical solution of the embodiments of the disclosure, the drawings of the embodiments will be briefly described in the following. It should be understood that the described drawings are only related to some embodiments of the disclosure and thus are not limitative of the scope of the disclosure. Those skilled in the art can obtain other drawings, without any inventive work, according to the drawings.

FIG. 1 is an upward view of an unmanned aerial vehicle in a housed state in an embodiment of the present disclosure;

FIG. 2 is a side view of the unmanned aerial vehicle in the housed state in the embodiment of FIG. 1;

FIG. 3 is an upward view of the unmanned aerial vehicle in a working state in the embodiment of FIG. 1;

FIG. 4 is a sectional view of FIG. 2 in an A-A direction;

FIG. 5 is a state diagram showing that the arm in FIG. 4 has moved to an unfolded position;

FIG. 6 is a schematic diagram showing that insertion matching of an arm matching part and an airframe matching part is achieved by an elastic part in an embodiment of the present disclosure;

FIG. 7 is a structural schematic diagram showing another arm-airframe connecting structure in an embodiment of the present disclosure;

FIG. 8 is a state schematic diagram showing that the arm in FIG. 7 has moved to an unfolded position;

FIG. 9 is a structural schematic diagram showing yet another arm-airframe connecting structure in an embodiment of the present disclosure;

FIG. 10 is a state schematic diagram showing that the arm in FIG. 9 has moved to an unfolded position;

FIG. 11 is a structural schematic diagram showing yet another arm-airframe connecting structure in an embodiment of the present disclosure;

FIG. 12 is a structural schematic diagram of a sleeve in the embodiment of FIG. 11.

FIG. 13 is a cross-sectional diagram showing a portion of a structure in which an arm is connected to an airframe in an embodiment of the present disclosure;

FIG. 14A is a side view of an arm in the embodiment of FIG. 13; and

FIG. 14B is a top view of an arm in the embodiment of FIG. 13.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. It is obvious that the described embodiments are just a part but not all of the embodiments of the disclosure.

Therefore, the detailed description on the embodiments of the present disclosure is not intended to limit the scope of protection of the present disclosure, but just shows part of the embodiments. Based on the embodiments in the present disclosure, all other embodiment(s) obtained by those skilled in the art, without any inventive work, should be within the scope of protection of the present disclosure.

It should be noted that the embodiments in the present disclosure and the characteristics and technical solutions in the embodiments can be combined mutually without confliction.

It should be noted that: similar numerals and letters represent similar items in the drawings below, and thus, once a certain item is defined in one drawing, the item does not need to be further defined and explained in the subsequent drawings.

Words such as “first”, “second” and the like do not denote or imply relative importance, but rather are used for distinguishing descriptions.

The embodiments of the present disclosure provide an arm-airframe connecting structure and an unmanned aerial vehicle including the same, wherein positions of arms relative to an airframe are maintained by insertion matching of arm matching parts and airframe matching parts, and thus, the positions of the arms with respect to the airframe can be effectively defined, and the problem of excessive shake of the arms in the flight process in the prior art is alleviated.

### First Embodiment

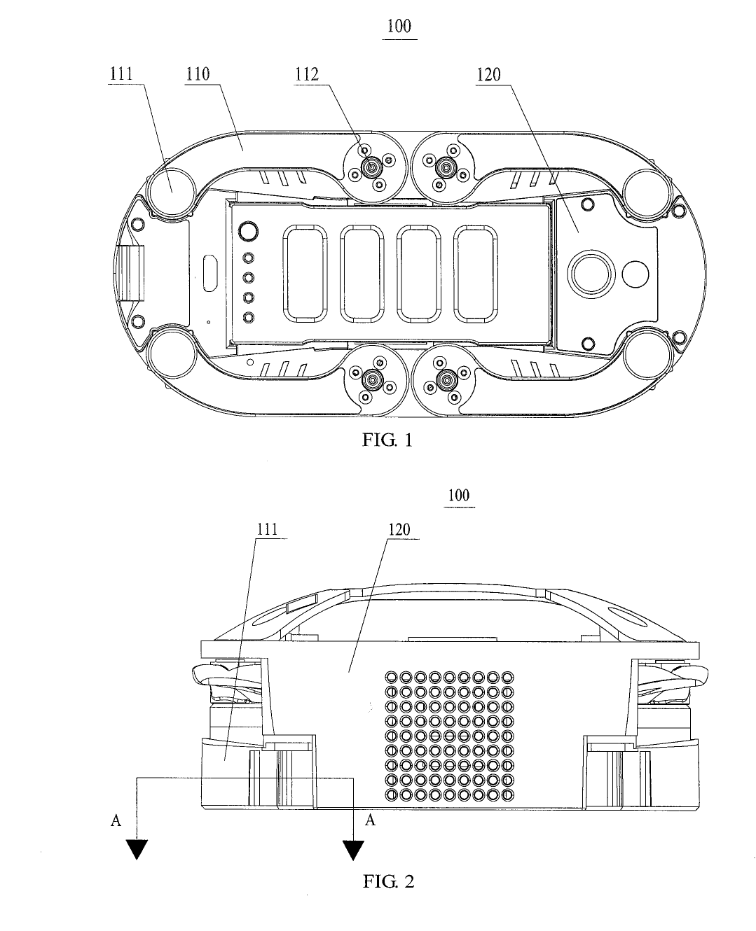

FIG. 1 is an upward view of an unmanned aerial vehicle 100 in a housed state in the embodiment of the present disclosure, and FIG. 2 is a side view of the unmanned aerial vehicle 100 in the housed state in the embodiment of the present disclosure. With reference to FIG. 1 and FIG. 2, the unmanned aerial vehicle 100, for example, is provided with four arms 110 and an airframe 120. Four arms 110 are movably connected with the airframe 120. Four arms 110 are centrally symmetrically connected to the lower part of the airframe 120. Namely, connection positions of the four arms 110 and the airframe 120 are centrally symmetrically provided. Herein, movable connection of the arms 110 and the airframe 120 means that at least one part of each arm 110 can move with respect to the airframe. For example, the four arms 110 are connected with the airframe 120 in a rotatable or retractable manner. The four arms 110 are incorporated into a contour of the airframe 120 at their respective housed positions. In the embodiment, rotatable connection of the arms 110 and the airframe 120 is illustrated for example.

Although not shown, the unmanned aerial vehicle provided by the embodiment further includes at least one of a circuit board, a battery, a sensor assembly, a heat radiating device and an image picking-up device.

Each arm 110 is provided with two opposite ends, i.e., a connecting end 111 and a power end 112. For example, a propeller and a motor (not shown) are provided at the power end 112 of each arm.

An arm-airframe connecting structure will be described in details below.

The connecting end 111 of each arm 110 is rotatably connected with the airframe 120. In FIG. 1, the power ends 112 of the arms 110 are close to the airframe 120, and are positioned at housed positions.

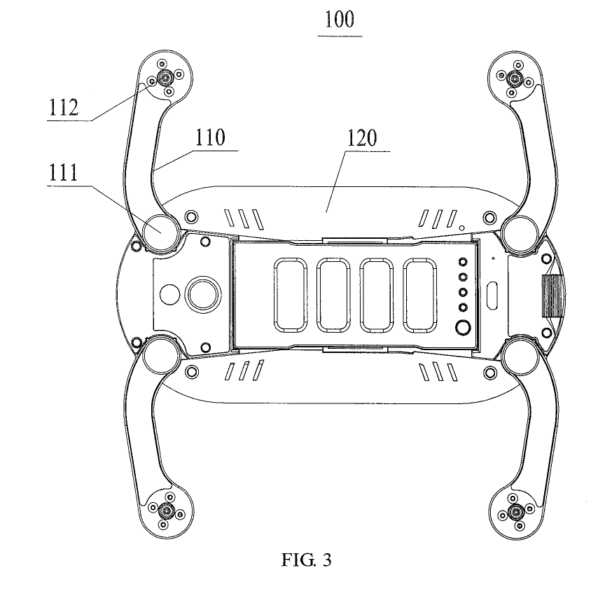

FIG. 3 is an upward view of the unmanned aerial vehicle 100 in a working state in the embodiment of the present disclosure. With reference to FIG. 3, the power ends 112 of the arms 110 can rotate around the connection positions of the connecting ends 111 and the airframe 120 so as to be away from the airframe 120. The arm 110 in an unfolded position is more far away from the airframe 120 than in the housed position. That is, when the arm 110 is in the unfolded position, the power end 112 of the arm 110 is more far away from the airframe 120, compared with a case the arm 110 is in the housed position. For example, when the four arms 110 are all positioned at their respective unfolded positions, the propellers and the motors on the power ends 112 work, so that the unmanned aerial vehicle 100 can be driven to fly.

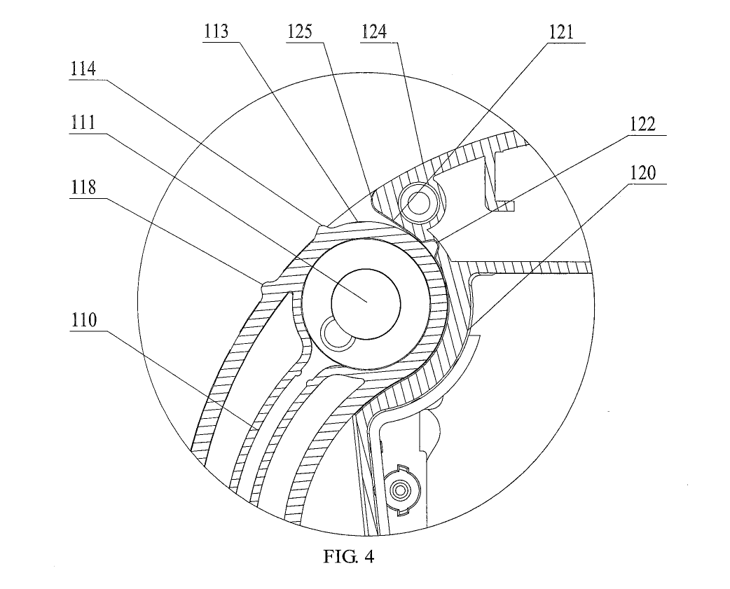

FIG. 4 is a sectional view of FIG. 2 in an A-A direction. With reference to FIG. 4, the connecting end 111 of the arm 110, for example, is provided with an arc outer surface 113. The airframe 120 is provided with an arc inner wall 121 adaptive to the outer surface 113. The inner wall 121 of the airframe 120 is opposite to the outer surface 113 of the connecting end 111 of the arm 110. An airframe matching part is provided on the arc wall 121 of the airframe 120. For example, a groove is disposed on the inner wall 121 so as to form an airframe matching part, i.e., a first airframe matching part 122. A center angle of the groove ranges from about 65 degrees to about 85 degrees. An arm matching part is provided on the outer surface 113 of the connecting end 111 of the arm 110. A projection is disposed on the outer surface 113 so as to form an arm matching part, i.e., a first arm matching part 114. The first arm matching part 114 rotates along with the arm 110. The first airframe matching part 122 is positioned on a rotation track of the first arm matching part 114. The first arm matching part 114 can enter the first airframe matching part 122 by insertion, and is tightly combined with the first airframe matching part 122.

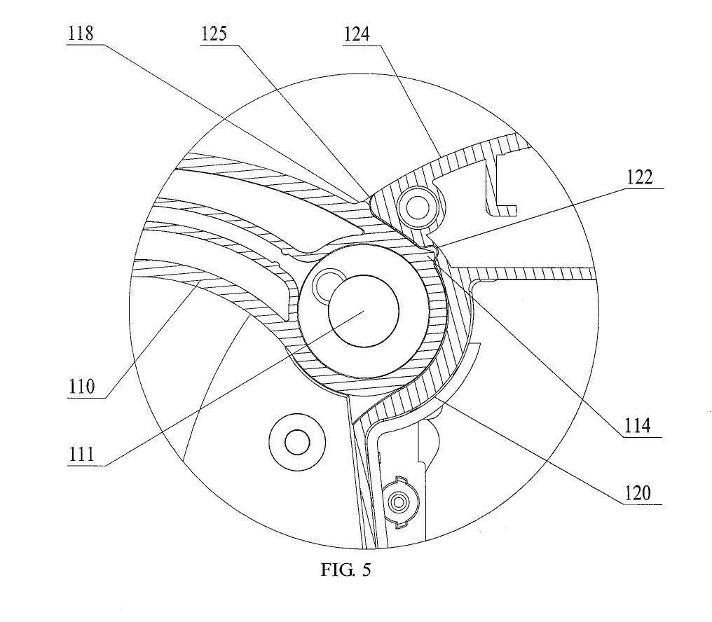

As shown in FIG. 4, the arm 110 is in the housed position with respect to the airframe 120, and the first arm matching part 114 is not in contact with the inner wall 121. FIG. 5 is a state diagram showing that the arm 110 in FIG. 4 has rotated to the unfolded position with respect to the airframe 120. With reference to FIG. 5, in the process that the power end 112 of the arm 110 rotates around the connection position of the connecting end 111 of the arm 110 and the airframe 120 so as to be away from the airframe 120, the first arm matching part 114 enters the first airframe matching part 122, and is insertion matched with the first airframe matching part 122. Therefore, the unfolded position of the arm 110 is effectively maintained by insertion matching of the first arm matching part 114 and the first airframe matching part 122. It is difficult to cause influence on the position of the arm 110 by vibration generated in the working process of the propeller and the motor, thereby effectively alleviating the problem of excessive shake of the arm 110 in the flight process.

It should be noted that in another embodiment, a projection disposed on the inner wall 121 can be adopted as the airframe matching part, and a groove disposed on the outer surfaces 113 can be adopted as the arm matching part.

With reference to FIG. 4, for example, another projection also can be provided on the outer surface 113 of the connecting end 111 of the arm 110 so as to form an abutting part 118; and a surface between the inner wall 121 and an outer wall 124 of the airframe 120 is provided as an abutting face 125, for example. When the arm 110 is positioned at the unfolded position relative to the airframe 120, the abutting part 118 abuts against the abutting face 125. Therefore, the unfolded position of the arm 110 with respect to the airframe 120 can be more firmly maintained.

In order to enable the first arm matching part 114 to insert into the first airframe matching part 122, an interval between the outer surface 113 of the connecting end 111 of the arm 110 and the inner wall 121 of the airframe 120 shall be smaller than a length of the first arm matching part 114 protruding from the outer surface 113. In order to enable the first arm matching part 114 to successfully pass through a space between the outer surface 113 and the inner wall 121 and enter the first airframe matching part 122, the first arm matching part 114, for example, can be made of an elastic material. Therefore, when the arm 110 rotates in the direction away from the airframe 120, the first arm matching part 114 generates deformation so as to enter the space between the outer surface 113 and the inner wall 121. After reaching the position of the first airframe matching part 122, the first arm matching part 114, for example, is restored to a normal state under the action of the elastic force thereof so as to form insertion matching of the first arm matching part 114 and the first airframe matching part 122.

It should be noted that the elastic material can be a plastic material having an elastic deformation capacity. It also should be noted that the connecting end 111 with the first arm matching part 114 provided thereon integrally can be made of an elastic material. In addition, the first airframe matching part 122 also can be made of an elastic material. Because the first airframe matching part 122 is the groove disposed on the inner wall 121, that the first airframe matching part 122 is made of the elastic material means that the part of the airframe 120 corresponding to the inner wall 121, is made of the elastic material. Naturally, both the first arm matching part 114 and the first airframe matching part 122 can be made of the elastic materials.

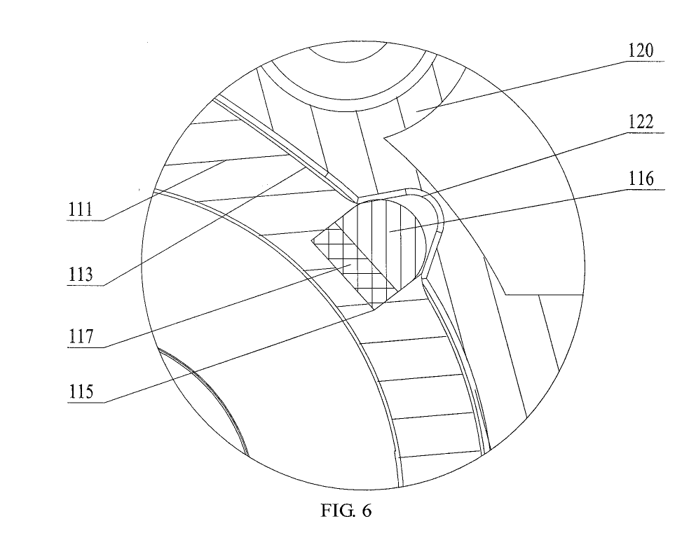

In another example, an elastic force for insertion matching of the arm matching part and the airframe matching part can be provided by an elastic part. FIG. 6 is a schematic diagram showing that the arm matching part and the airframe matching part are driven to form insertion matching by an elastic part in the embodiment of the present disclosure. With reference to FIG. 6, a chute 115 is disposed on the outer surface 113 of the connecting end 111 of the arm 110, a sliding block 116 used as the arm matching part is provided in the chute 115 in a slidable manner, and a resilient pad 117 used as the elastic member is provided in the chute 115. For example, in the process that the arm 110 rotates from the housed position to the unfolded position, in a case that the sliding block 116, along with the rotation of the arm 110, enters the space between the outer surface 113 and the inner wall 121 without reaching the first airframe matching part 122, the resilient pad 117 is in a compressed state. When the sliding block 116 reaches the first airframe matching part 122, the sliding block 116 is ejected from the chute 115 by a restoring force of the resilient pad 117. Under the action of the restoring force of the resilient pad 117, the sliding block 116 enters the first airframe matching part 122, and is matched with the first airframe matching part 122 by inserting. When the sliding block 116, along with rotation of the arm 110, reenters the space between the outer surface 113 and the inner wall 121, under the action of the inner wall 121, the sliding block 116 overcomes the restoring force of the resilient pad 117 to reenter the chute 115. It should be noted that a spring also can be adopted as the elastic part.

In another example, insertion matching of the arm matching parts and the airframe matching parts also can be achieved by an adsorption force. For example, without arranging elastic parts in the chutes 115, each sliding block 116 is composed of a magnetic metal, and magnets are provided in the airframe 120. Therefore, when the arm 110 is positioned at the unfolded position, under the action of adsorption of magnet, the sliding block 116 enters the first airframe matching part 122, and is matched with the first airframe matching part 122 by inserting. When the arm 110 rotates, under the action of the inner wall 121, the sliding block 116 overcomes the adsorption force of the corresponding magnet to enter the chute 115.

### Second Embodiment

The second embodiment of the present disclosure provides an arm-airframe connecting structure. The arm-airframe connecting structure can have substantially the same structure as the arm-airframe connecting structure provided by the first embodiment, except for the number of the airframe matching parts. Therefore, repeated descriptions for the same component parts will be omitted herein, and the same terms and the same reference numerals will be used to refer to the same component parts. The embodiment is illustrated by adopting grooves as the airframe matching parts and adopting a projection as the arm matching part for example.

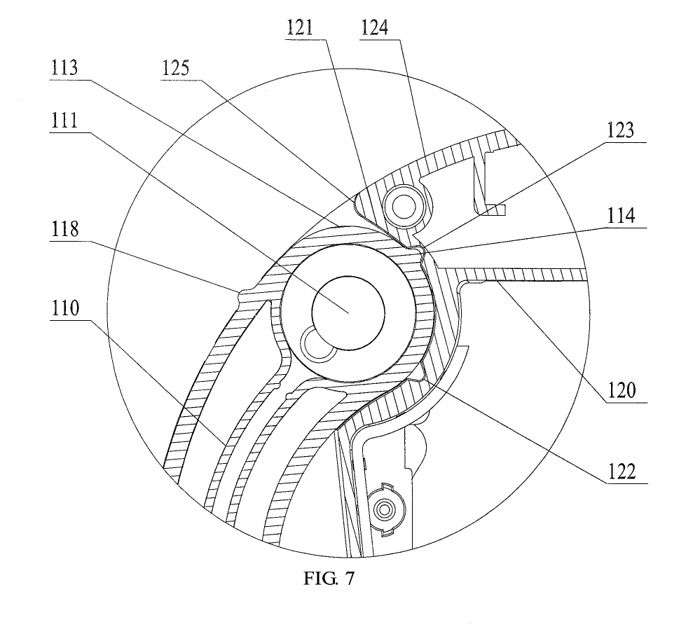

FIG. 7 is a structural schematic diagram of the arm-airframe connecting structure provided by the second embodiment of the present disclosure.

With reference to FIG. 7, two airframe matching parts are provided on the airframe 120. For example, two grooves are provided separately on the inner wall 121 to form two airframe matching parts, i.e., the first airframe matching part 122 and a second airframe matching part 123. One arm matching part is provided on the arm 110. One projection on the outer surface 113 of the connecting end 111 of the arm 110 is provided as an arm matching part, i.e., the first arm matching part 114. The first arm matching part 114 moves along with rotation of the arm 110. The first airframe matching part 122 and the second airframe matching part 123 are positioned on the rotation track of the first arm matching part 114. The first arm matching part 114 can enter the first airframe matching part 122 and the second airframe matching part 123 by inserting, and is tightly combined with the first airframe matching part 122 and the second airframe matching part 123.

In FIG. 7, the arm 110 is in the housed position, and the first arm matching part 114 and the second airframe matching part 123 form insertion matching. Therefore, the housed position of the arm 110 is effectively maintained by insertion matching of the first arm matching part 114 and the second airframe matching part 123.

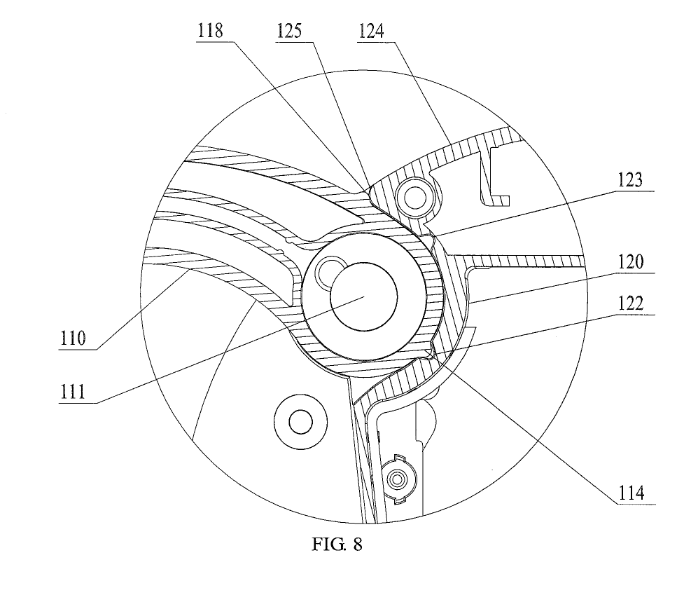

FIG. 8 is a state schematic diagram showing the arm in FIG. 7 has moved to the unfolded position. With reference to FIG. 8, the power end 112 of the arm 110 rotates around the connection position of the connecting end 111 and the airframe 120 in the direction away from the airframe 120, and the first arm matching part 114 enters the first airframe matching part 122 and is matched with the first airframe matching part 122 by inserting. Therefore, the unfolded position of the arm 110 is effectively maintained by insertion matching of the first arm matching part 114 and the first airframe matching part 122. It is difficult to cause influence on the position of the arm 110 by vibration generated in the working process of the propeller and the motor, thereby effectively alleviating the problem of excessive shake of the arm 110 in the flight process.

Therefore, through rotation of the arm 110, the first arm matching part 114 is optionally matched with the first airframe matching part 122 and the second airframe matching part 123 by inserting, so that the housed position or the unfolded position of the arm 110 can be effectively maintained.

It should be noted that in another example, other airframe matching parts can be further provided between the first airframe matching part 122 and the second airframe matching part 123 so that the arm 110 can be maintained in other positions between the housed position and the unfolded position.

### Third Embodiment

The third embodiment of the present disclosure provides an arm-airframe connecting structure. The arm-airframe connecting structure can have substantially the same structure as the arm-airframe connecting structure provided by the second embodiment, except for the number of the arm matching parts. Therefore, repeated descriptions for the same component parts will be omitted herein, and the same terms and the same reference numerals will be used to refer to the same component parts. The embodiment is illustrated by adopting grooves as the airframe matching parts and adopting projections as the arm matching parts for example.

The embodiment is illustrated by using grooves as the airframe matching parts and using projections as the arm matching parts for example.

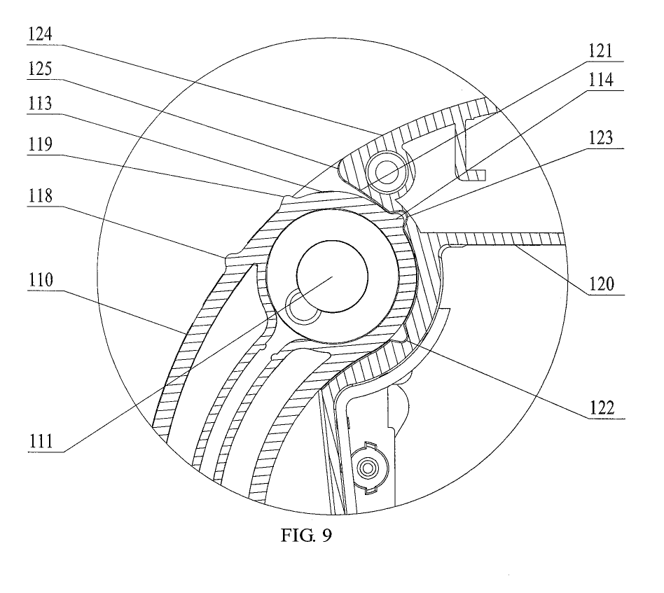

FIG. 9 is a structural schematic diagram of the arm-airframe connecting structure provided by the third embodiment of the present disclosure.

With reference to FIG. 9, two airframe matching parts are provided on the airframe 120. For example, two grooves are provided separately on the inner wall 121 to form two airframe matching parts, i.e., the first airframe matching part 122 and the second airframe matching part 123. Two arm matching parts are provided on the arm 110. For example, two projections are provided on the outer surface 113 so as to form two arm matching parts, i.e., the first arm matching part 114 and a second arm matching part 119. The first arm matching part 114 and the second arm matching part 119 rotate along with the arm 110. The first airframe matching part 122 and the second airframe matching part 123 are positioned on the rotation tracks of the first arm matching part 114 and the second arm matching part 119.

In FIG. 9, the arm 110 is in the housed position, and the first arm matching part 114 is matched with the second airframe matching part 123 by inserting. Therefore, the housed position of the arm 110 is effectively maintained by insertion matching of the first arm matching part 114 and the second airframe matching part 123.

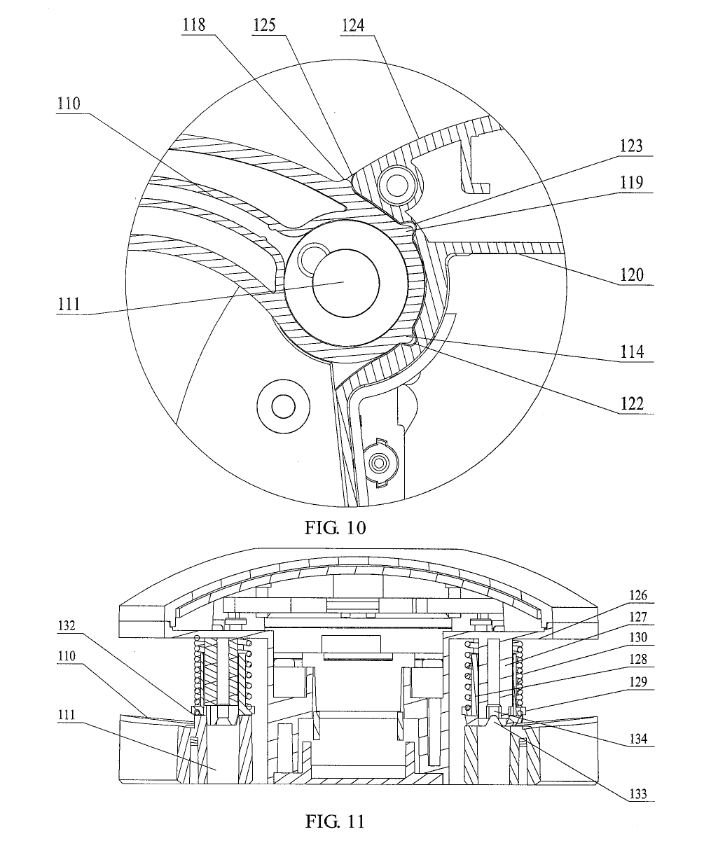

FIG. 10 is a state schematic diagram showing the arm 110 in FIG. 9 has rotated to the unfolded position. With reference to FIG. 10, the power end 112 of the arm 110 rotates around the connection positions of the connecting end 111 and the airframe 120 in the direction away from the airframe 120. The first arm matching part 114 enters the first airframe matching part 122 and is matched with the first airframe matching part 122 by insertion; the second arm matching part 119 enters the second airframe matching part 123 and is matched with the second airframe matching part 123 by insertion. Therefore, the unfolded position of the arm 110 is effectively maintained by insertion matching of the first arm matching part 114 and the first airframe matching part 122 and insertion matching of the second arm matching part 119 and the second airframe matching part 123. Therefore, the arm 110 will be more firmly maintained in the unfolded position, thus improving stability of the arm 110 during the flight.

### Fourth Embodiment

The four embodiment of the present disclosure provides an arm-airframe connecting structure. The arm-airframe connecting structure can have substantially the same construction as the arm-airframe connecting structure provided by the second embodiment, except for the arrangement and the number of the airframe matching parts and the arm matching parts. Therefore, repeated descriptions for the same component parts will be omitted herein, and the same terms and the same reference numerals will be used to refer to the same component parts.

FIG. 11 is structural schematic diagram of the arm-airframe connecting structure provided by the fourth embodiment of the present disclosure.

With reference to FIG. 11, the airframe 120 is provided with a downward position limiting face 126. Camshafts 127, adopted as guide parts, are substantially vertically fixed on the position limiting face 126. Sleeves 128, adopted as limiting parts, are sleeved on the camshaft 127 in an up-and-down slidable manner respectively, and inner surfaces of the sleeve 128 is matched with an outer surfaces of the camshafts 127 correspondingly, so that the sleeves 128 cannot rotate with respect to the corresponding camshafts 127. Convex rings 129 radically extending outwards are provided at a lower end of the sleeves 128 respectively. The elastic parts adopting reset springs 130 is sleeved on the sleeve 128 respectively, with one end of the reset spring 130 pressed against the position limiting face 126 and the other end of the reset spring 130 pressed against the convex ring 129. Elastic forces are applied onto the sleeve 128 by the reset springs 130, to drive the sleeve 128 away from the position limiting face 126. The lower end face of the sleeve 128 is provided as an airframe matching face 131.

The connecting end 111 of the arm 110 is rotatably connected with the airframe 120 by a rotating shaft which is not shown in the drawings. An upper surface of the connecting end 111 is provided as an arm matching face 132 opposite to the airframe matching face 131.

A projection 133 is provided on the arm matching face 132 so as to form one arm matching part.

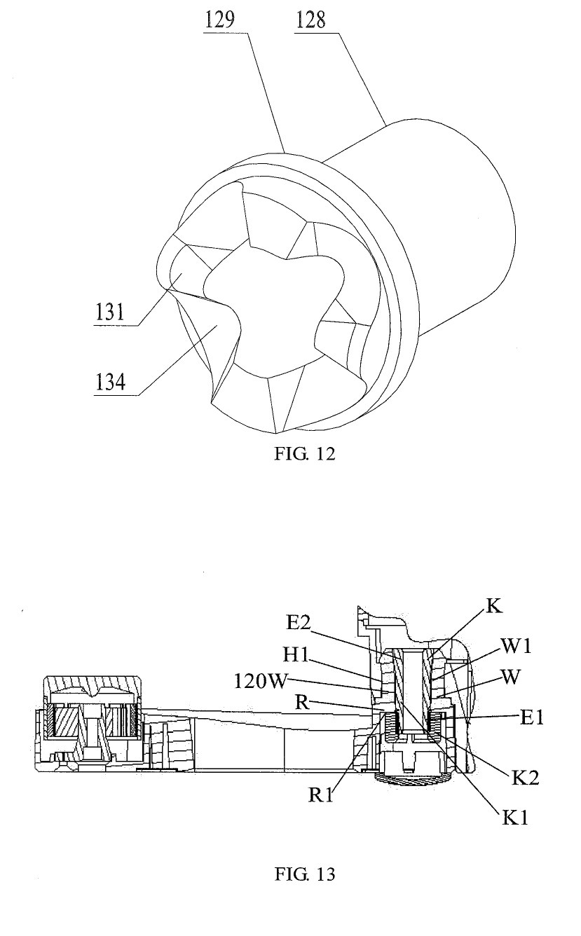

With reference to FIG. 12, FIG. 12 is a structural schematic diagram of the sleeve 128 in the embodiment of the present disclosure. Four grooves 134 are disposed on the airframe matching face 131 of the sleeve 128 so as to form four airframe matching parts.

Under the action of the elastic force of the reset spring 130, the projection 133 enters one of the grooves 134, and is matched with the groove 134 by inserting. Therefore, the position of the arm 110 is maintained. Along with rotation of the arm 110, the projection 133 is separated from the one of the grooves 134 matched therewith, and the sleeve 128 overcomes the elastic force of the reset spring 130 to move upwards. Then, the projection 133 enters another groove 134, and is insertion matched with the groove 134 under the action of the elastic force of the reset spring 130.

In the embodiment, the projection 133 is matched with the grooves 134 at different positions, so that the arm 110 can be optionally maintained at four positions. Among the four positions, one position is the unfolded position, and one position is the housed position.

It should be noted that the number of the airframe matching parts and the number of the arm matching parts are not limited in the cases described above. For example, the number of the arm matching parts can be smaller than the number of the airframe matching parts. For example, two airframe matching parts and one arm matching part are provided, or four airframe matching parts and two arm matching parts are provided, etc. It also should be noted that the airframe matching parts can adopt the projections disposed on the airframe matching face 131, and the arm matching parts can adopt the grooves disposed on the arm matching faces 132.

It should be understood that although the arm matching parts are bonded with the airframe matching parts in an insertion matching manner in the embodiments above, the embodiments of the present disclosure are not limited thereto. In another embodiment, for example, the arm matching part is embedded into a side of the connecting end 111 of the arm which is close to the inner wall 121 of the airframe, without protruding out of the surface 113 of the connecting end 111 of the arm, and the corresponding airframe matching part is embedded into the inner wall 121 of the airframe without being sunken on the inner wall 121. In the embodiment, for example, the arm matching part and the airframe matching part are bonded with each other by magnetic suction so as to limit the position of the arm with respect to the airframe.

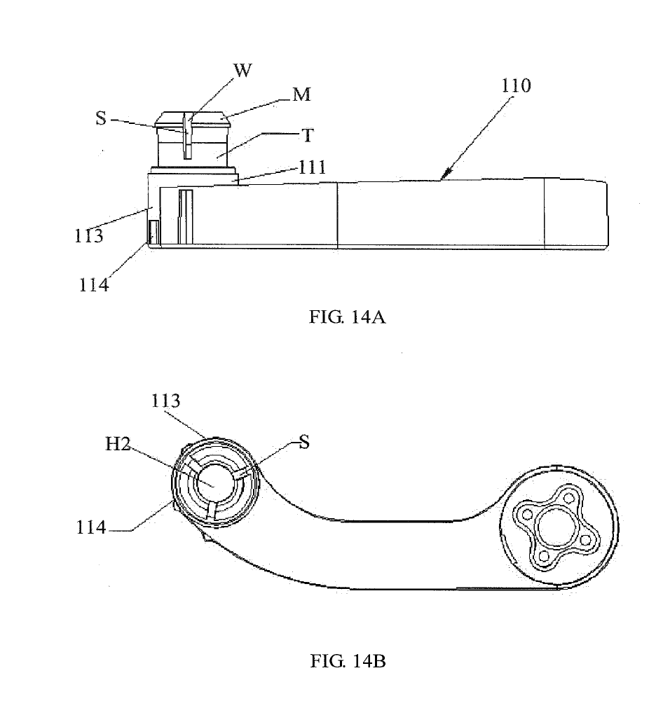

Referring to FIGS. 13 to 14B, in an embodiment, at the connecting end 111 of the arm 110, the arm-airframe connecting structure further includes a protrusion portion T extending in a direction (e.g., a vertical direction) perpendicular to a plane in which the arm moves (e.g., a horizontal plane). For example, see FIG. 13, the arm matching part 114 is for example disposed on an outer surface 113 of the connecting end 111. The protrusion portion T is disposed on an upper surface of the connecting end 111 of the arm 110 which abutting the outer surface 113. A first through hole H1 through which the protrusion portion T passes is provided in the airframe 120. The protrusion portion T is provided with a flange M on the top. The flange M is configured to prevent the protrusion portion T from detaching from the first through hole H1. For example, an outer diameter of the flange M is larger than a diameter of the opening of the first through hole H1 adjacent to the flange M. The bottom portion of the protrusion portion T is fixedly connected to the connecting end 111 of the arm 110 located below the first through hole H1, and the top of the protrusion portion T is confined above the first through hole H1 via the flange M. Thus, the protrusion portion T can be rotated in the first through hole H1 without detaching from the first through hole H1.

For example, the protrusion portion T has a cylindrical shape. A second through hole H2 is provided in the protrusion portion T, and the second through hole H2 is provided coaxially with the first through hole H1, for example.

For example, the wall W of the protrusion portion T has an inner surface W1 and an outer surface W2. At least one slot S penetrating the wall W is provided in the cylinder wall W of the protrusion portion T. Referring to FIG. 14B, the wall W of the protrusion portion T is provided with three slots S penetrating the tube wall W, each extending, for example, in a direction perpendicular to the plane of movement of the arm. Thus, the outer diameter of the protrusion portion T is variable under an action of an external force. Here, the external force means a force applied to the protrusion portion T by any other object other than the protrusion portion T itself. For example, the outer diameter of the protrusion portion T is made smaller by an external force so that the flange M located at the top of the protrusion portion T can enter into the first through hole H1 of the airframe 120, so that the arm 110 is mounted on the airframe 120; and when the protrusion portion T enters into the airframe, the protrusion portion T is restored to its original outer diameter by its own elasticity, and is further locked at the airframe 120 by the flange M. It should be understood that the number and extending direction of the slot(s) S is not limited in embodiments of the present disclosure.

For example, referring to FIG. 13, the arm-airframe connecting structure may further include a reinforcing member K provided in the second through hole H2 of the protrusion portion T. The reinforcing member K is configured to press the wall W of the protrusion portion T to be pressed against a sidewall 120W of the airframe 120 adjacent to the first through hole H1.

For example, referring to FIG. 13, the reinforcing member K includes a bolt K1 and a nut K2 that engages with each other through screw threads. The bolt K1 has a first end E1 and a second end E2 opposite to each other. The first end E1 is provided with a thread that matches with a thread of the nut K2, and the second end E2 is free of thread. The second end E2 of the bolt K1 is closer to the flange M of the protrusion portion T with respect to the first end E1, and has a shape of, for example, circular truncated cone. The bolt K1 for example is hollow, so that a wire can pass through the bolt K1. A step portion R is disposed on the inner surface W1 of the wall W of the protrusion portion T, and the step portion R is configured to limit the movement of the nut K2 in the second through hole H2. For example, by adjusting the relative positions of the bolts K1 and the nuts K2 bonded with each other, the nut K2 located below the step portion R abuts against the lower surface R1 of the step portion R, and the second end E2 of the bolt K1 which has the shape of circular truncated cone abuts against the wall W of the protrusion portion T, such that the wall W of the protrusion portion T is closely pressed against the wall 120W of the airframe 120 adjacent to the first through hole H1.

The above is only part of embodiments of the present disclosure, and not intended to limit the present disclosure. Those skilled in the art can make various changes and variations to the embodiments of the present disclosure. Any modifications, equivalent replacements, improvements and the like within the spirit and principle of the present disclosure shall fall within the scope of protection of the present disclosure.

The application claims the priorities of the Chinese patent application No. 201620366873.9 filed on Apr. 27, 2016 and the Chinese patent application No. 201620883820.4 filed on Aug. 15, 2016, the contents of which are incorporated herein by reference in its entirety.

1. An arm-airframe connecting structure, configured to movably connect an airframe and an arm, the arm being switchable between an unfolded position and a housed position with respect to the airframe, wherein, the arm-airframe connecting structure comprises:
at least one arm matching part provided on the arm; and
at least one airframe matching part provided on the airframe,
wherein, the at least one arm matching part and the at least one airframe matching part are configured to be bonded with each other so as to maintain at least one of the unfolded position and the housed position of the arm with respect to the airframe.

2. The arm-airframe connecting structure according to claim 1, wherein, the at least one airframe matching part is positioned on movement track of the at least one arm matching part.

3. The arm-airframe connecting structure according to claim 2, wherein, an end of the arm connected to the airframe has an arc outer surface, the airframe has an arc inner wall cooperating with the arc outer surface of the arm, the at least one arm matching part is disposed on the arc outer surface of the end of the arm, and the at least one airframe matching part is disposed on the arc inner wall of the airframe.

4. The arm-airframe connecting structure according to claim 2, wherein, the at least one arm matching part is a first projection or a first groove disposed on the arc outer surface, and the at least one airframe matching part is a second recess or a second projection disposed on the arc inner wall and configured to be bonded with the at least one arm matching part.

5. The arm-airframe connecting structure according to claim 4, wherein, a spacing between the arc outer surface of the arm and the arc inner wall of the airframe is smaller than a first height by which the first projection protrudes from the arc outer surface, or smaller than a second height by which the second projection protrudes from the arc inner wall.

6. The arm-airframe connecting structure according to claim 1, wherein, at least one of the at least one arm matching part and the at least one airframe matching part is formed of an elastic material.

7. The arm-airframe connecting structure according to claim 4, wherein, the at least one arm matching part comprises a chute provided on the arm, an elastic member provided in the chute, and a sliding block provided on the elastic member and serving as the first projection.

8. The arm-airframe connecting structure according to claim 4, wherein the at least one arm matching part comprises a chute provided on the arc outer surface of the arm, and a sliding block made of a magnetic metal and serving as the first projection, and in the unfolded position of the arm, the sliding block enters into the at least one airframe matching part under a suction of a magnet provided in the airframe.

9. The arm-airframe connecting structure according to claim 4, wherein, a center angle of the first groove or a center angle of the second groove ranges from about 65 degrees to about 85 degrees.

10. The arm-airframe connecting structure according to claim 2, further comprising an abutting part provided on the arc outer surface, and in the case where the arm is in the unfolded position, the abutting part abuts against the airframe.

11. The arm-airframe connecting structure according to claim 1, wherein, the at least one arm matching part comprises a first arm matching part, the at least one airframe matching part comprises a first airframe matching part and a second airframe matching part spaced apart from each other, the housed position of the arm is maintained by insertion matching of the first arm matching part with the second airframe matching part, and the unfolded position of the arm is maintained by insertion matching of the first arm matching part with the first airframe matching part.

12. The arm-airframe connecting structure according to claim 11, wherein, the at least one arm matching part further comprises a second arm matching part spaced apart from the first arm matching part, and the unfolded position of the arm is further maintained by insertion matching of the second arm matching part with the second airframe matching part.

13. The arm-airframe connecting structure according to claim 1, wherein the airframe further has an airframe matching face downwardly facing to the arm, and the at least one airframe matching part is disposed on the airframe matching face to face to the arm; the arm further has an arm matching face facing to the airframe matching face, and the at least one arm matching part is provided on the arm matching face to form an insertion matching with the at least one airframe matching part.

14. The arm-airframe connecting structure according to claim 13, wherein, the airframe further comprises a position limiting face facing to the arm, a guide part perpendicularly fixed to the position limiting face, a limiting part sheathed on the guide part to slide upwards and downwards with respect to the position limiting face, a convex ring provided at a lower end of the limiting part and extending outwardly with respect to the limiting part, and an elastic part for applying an elastic force to the limiting part to drive the limiting part away from the position limiting face, one end of the elastic part is pressed against the position limiting face, and another end of the elastic part is pressed against the convex ring, and a lower end surface of the limiting part is provided as the airframe matching face.

15. The arm-airframe connecting structure according to claim 13, wherein, the at least one arm matching part is a projection or a groove disposed on the arm matching face, and the at least one airframe matching part is a recess or projection configured to cooperate with the at least one arm matching part.

16. The arm-airframe connecting structure according to claim 15, wherein, the at least one arm matching part is one projection, the at least one airframe matching part is two recesses provided at intervals, and the one projection cooperates with the two grooves under an action of the elastic part to respectively maintain the housed position and the unfolded position of the arm.

17. The arm-airframe connecting structure according to claim 15, wherein, the at least one arm matching part is two projections spaced apart from each other, the at least one airframe matching part is four grooves spaced apart from each other, the two projections selectively cooperate with the four grooves under an action of the elastic part to respectively maintain the housed position and the unfolded position of the arm.

18. The arm-airframe connecting structure according to claim 14, wherein, the guide portion is a camshaft, the limiting part is a sleeve sheathed on the cam shaft, and the elastic part is a reset spring.

19. The arm-airframe connecting structure according to claim 18, wherein, the sleeve is non-rotating relative to the camshaft.

20. The arm-airframe connecting structure according to claim 1, further comprising: at a connecting end of the arm connected to the airframe, a protrusion portion extending in a direction perpendicular to a plane in which the arm moves, wherein a first through hole through which the protrusion portion passes is provided in the airframe, and a top of the protrusion portion is provided with a flange configured to prevent the protrusion portion from detaching from the first through hole.

21. The arm-airframe connecting structure according to claim 20, wherein, the protrusion portion has a cylindrical shape in which a second through hole coaxial with the first through hole is provided.

22. The arm-airframe connecting structure according to claim 21, wherein, at least one slot is provided in a wall of the protrusion portion and penetrates through the wall of the protrusion portion, so that an outer diameter of the protrusion portion is variable under an external force.

23. The arm-airframe connecting structure according to claim 22, further comprising: a reinforcing member disposed in the second through hole of the protrusion portion, the reinforcing member is configured to force the wall of the protrusion portion to be pressed against a sidewall of the airframe adjacent to the first through hole.

24. The arm-airframe connecting structure according to claim 23, wherein, the reinforcement member comprises a bolt and a nut, an end of the bolt having no threads and close to the flange of the protrusion portion has a shape of circular truncated cone, a step portion is disposed on an inner surface of the wall of the protrusion portion, and the step portion is configured to restrict movement of the nut in the second through hole.

25. An unmanned aerial vehicle, comprising:
an airframe;
an arm movably connected to the airframe and switchable between an unfolded position and a housed position with respect to the airframe; and
an arm-airframe connecting structure, comprising:
at least one arm matching part provided on the arm; and
at least one airframe matching part provided on the airframe,
wherein, the at least one arm matching part and the at least one airframe matching part are configured to be bonded with each other so as to maintain at least one of the unfolded position and the housed position of the arm with respect to the airframe.

26. The unmanned aerial vehicle according to claim 25, wherein, the arm of the unmanned aerial vehicle is incorporated into a contour of the airframe at the housed position.

27. An unmanned aerial vehicle, comprising:
an airframe;
an arm movably connected to the airframe and switchable between an unfolded position and a housed position with respect to the airframe; and
an arm-airframe connecting structure for maintaining the housed position and the unfolded position of the arm with respect to the airframe,
wherein the arm of the unmanned aerial vehicle is incorporated into a contour of the airframe at the housed position.
